(19) United States
(12) Patent Application Publication
(10) Pub. No.: US 2021/0094484 A1
(43) Pub. Date: Apr. 1, 2021

(54) VEHICLE INFORMATION CONVEYING DEVICE

(71) Applicant: TOYODA GOSEI CO., LTD., Kiyosu-shi (JP)

(72) Inventors: Kunihiro NOKURA, Kiyosu-shi (JP); Tetsuya ARAKAWA, Kiyosu-shi (JP); Eiji HANAI, Kiyosu-shi (JP); Ayaka YAGI, Kiyosu-shi (JP); Takahiro YAMADA, Kiyosu-shi (JP)

(21) Appl. No.: 17/032,435

(22) Filed: Sep. 25, 2020

(30) Foreign Application Priority Data
Sep. 30, 2019 (JP) 2019-178633

(51) Int. Cl. B60R 13/04; B60K 37/02; B60K 37/04

(52) U.S. Cl. CPC B60R 13/04; B60K 37/02; B60K 37/04; B60K 2370/797; B60K 2370/332; B60K 2370/1575; B60K 2370/193

(57) ABSTRACT

A vehicle information conveying device includes at least one ornamental surface member and at least one ornamental surface deformation unit. The ornamental surface member is elastic and deformable. The ornamental surface member includes an ornamental surface designed to be viewed by a user of a vehicle. The ornamental surface deformation unit is configured to drive the ornamental surface member and deform the ornamental surface when information that is to be conveyed to the user is present.

### BACKGROUND

### 1. Field

The following description relates to a vehicle information conveying device.

### 2. Description of Related Art

An information conveying device that conveys information to a user of a vehicle by outputting light, sound, or the like is known in the art. Japanese Laid-Open Patent Publication No. 2017-102664 describes an example of a device that changes the mode of the output light or output sound in accordance with the content of information that is to be conveyed to the user.

Components of a vehicle have constantly been improving. There is always a demand for further improving the conventional information conveying device to meet the requirements for vehicles that are subject to technological progresses.

### SUMMARY

It is an object of the present disclosure to provide a vehicle information conveying device that effectively conveys information to a user of a vehicle.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a vehicle information conveying device includes at least one ornamental surface member that is elastic and deformable. The at least one ornamental surface member includes an ornamental surface designed to be viewed by a user of a vehicle. The vehicle information conveying device also includes at least one ornamental surface deformation unit configured to drive the ornamental surface member and deform the ornamental surface when information that is to be conveyed to the user is present.

Other features and aspects will be apparent from the following detailed description, the drawings, and the claims.

### BRIEF DESCRIPTION OF THE DRAWINGS

FIG. 1 is a perspective view of a vehicle in which an information conveying device is installed.

FIG. 2 is a diagram showing an ornamental surface member and an information conveying unit arranged on a door.

FIG. 3 is a diagram showing an ornamental surface member and an information conveying unit arranged in a dashboard and an inner trim.

FIG. 4 is a cross-sectional view taken from the vicinity of an information conveying unit arranged at an inner side of the ornamental surface member.

FIG. 5 is another cross-sectional view taken from the vicinity of the information conveying unit arranged at an inner side of the ornamental surface member.

FIG. 6 is a schematic block diagram illustrating the configuration of the information conveying device.

FIG. 7 is a flowchart showing the processing procedure of information conveying control.

FIG. 8 is a control table used for information conveying control.

FIG. 9 is a diagram illustrating the operation of the information conveying device.

FIG. 10 is a diagram illustrating the operation of the information conveying device.

FIG. 11 is a diagram illustrating the operation of the information conveying device.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

A vehicle information conveying device (hereafter simply referred to as information conveying device) 40 according to one embodiment will now be described with reference to the drawings.

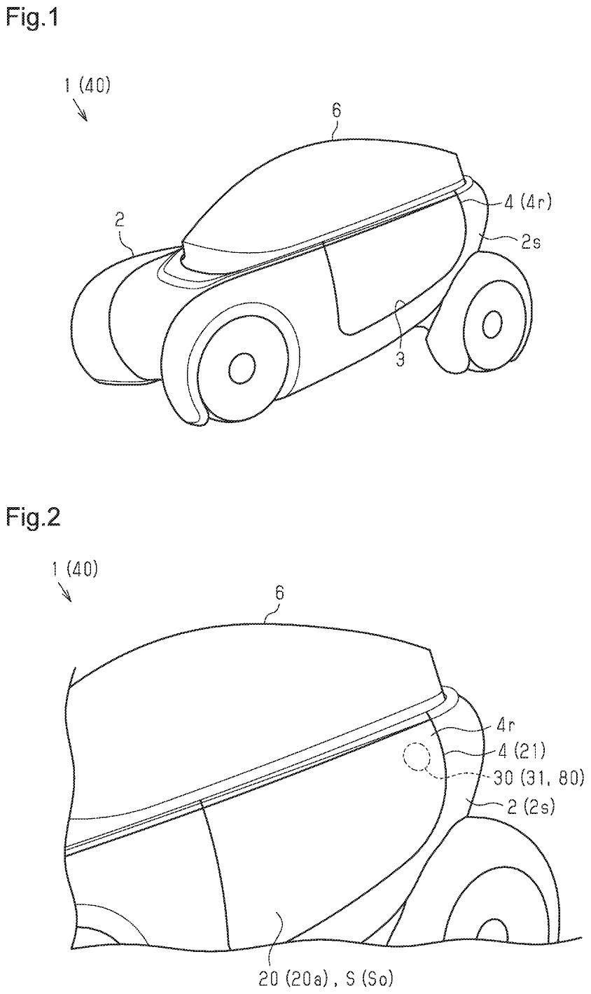

As shown in FIG. 1, a vehicle 1 of the present embodiment includes a vehicle body 2, a door 4, and a canopy 6. The door 4 opens and closes a door opening 3 formed in a side surface 2s of the vehicle body 2. The canopy 6 is dome-shaped and covers the passenger compartment from above. The door 4 is configured to be a swing door that is pivoted about its front end. The canopy 6 is made of a transparent material. The canopy 6 opens and closes in the vertical direction about its rear end. The door 4 and the canopy 6 of the vehicle 1 operate in cooperation with each other so that a user can easily enter and exit the vehicle 1.

As shown in FIG. 2, the vehicle 1 includes a sheet-like first ornamental surface member 20a arranged on the door 4. Specifically, the first ornamental surface member 20a is made of an elastic material, such as silicone rubber, so as to be deformable. The first ornamental surface member 20a covers the door 4, which forms an exterior member 21 of the vehicle 1, from the outer side of the vehicle. Thus, the first ornamental surface member 20a forms an ornamental surface So designed to be viewed by the user outside the vehicle.

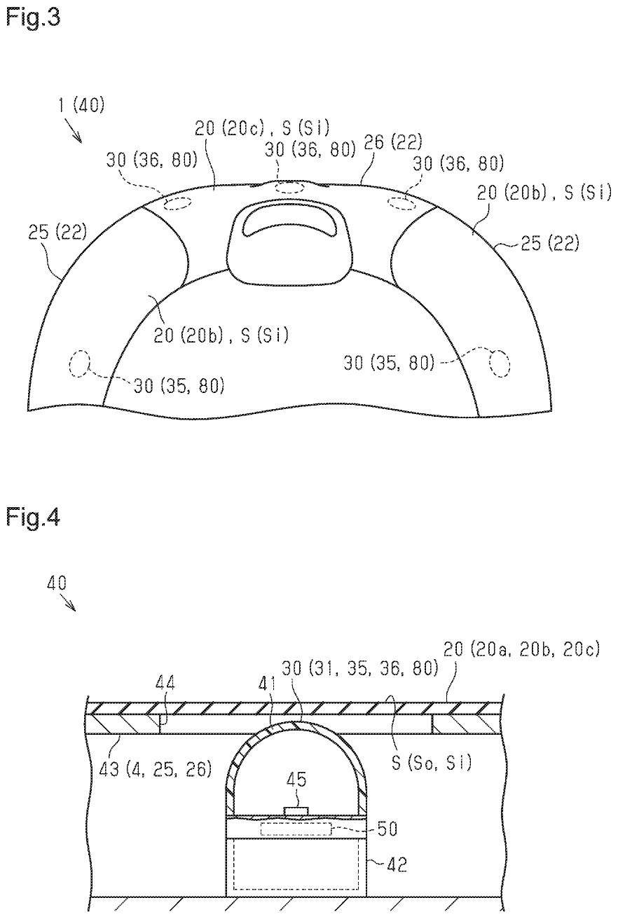

As shown in FIG. 3, the vehicle 1 includes inner trims 25 and a dashboard 26 arranged inside the vehicle. The vehicle 1 further includes sheet-like second and third ornamental surface members 20b, 20c arranged on the inner trims 25 and the dashboard 26. Specifically, the second and third ornamental surface members 20b, 20c are elastic and deformable in the same manner as the first ornamental surface member 20a arranged on the door 4. In the vehicle 1, the second and third ornamental surface members 20b, 20c, which are for interior members 22, are made of a material that is softer than that of the first ornamental surface member 20a, which is for the exterior member 21. The second and third ornamental surface members 20b, 20c cover the inner trims 25 and the dashboard 26, respectively, from an outer side inside the vehicle. Thus, the second and third ornamental surface members 20b, 20c each form an ornamental surface Si designed to be viewed by the user inside the vehicle.

As shown in FIGS. 2 to 4, the vehicle 1 includes a first information conveying unit 31, second information conveying units 35, and third information conveying units 36. As shown in FIG. 2, the first information conveying unit 31 is arranged at the inner side of the first ornamental surface member 20a in the vicinity of a rear end 4r of the door 4 and the vicinity of the upper end of the door 4. The vicinity of the upper end of the door 4 is a region corresponding to the belt line. As shown in FIG. 3, the second information conveying units 35 are arranged at the inner sides of the second ornamental surface members 20b arranged on the inner trims 25 at positions within reach of the occupant seated on the vehicle sheet (not shown) inside the vehicle. In the vehicle 1, one of each of the first and second information conveying units 31, 35 is arranged on each of the right and left doors 4 and the right and left inner trims 25. Thus, in the present embodiment, there are two first information conveying units 31 and two second information conveying units 35. The dashboard 26 extends from the front side toward the rear side of the vehicle in a manner extending from a central position with respect to a widthwise direction of the vehicle toward the right and left sides of the vehicle. The third information conveying units 36 are arranged at the inner side of the third ornamental surface member 20c at a central position and left and right positions of the dashboard 26, which is curved to be substantially U-shaped. Thus, in the present embodiment, there are three third information conveying units 36.

The first to third ornamental surface members 20a, 20b, 20c are referred to as ornamental surface members 20. The first to third information conveying units 31, 35, 36 are referred to as information conveying units 30. As shown in FIG. 4, the vehicle 1 includes the information conveying units 30 arranged at the inner sides of the corresponding ornamental surface members 20.

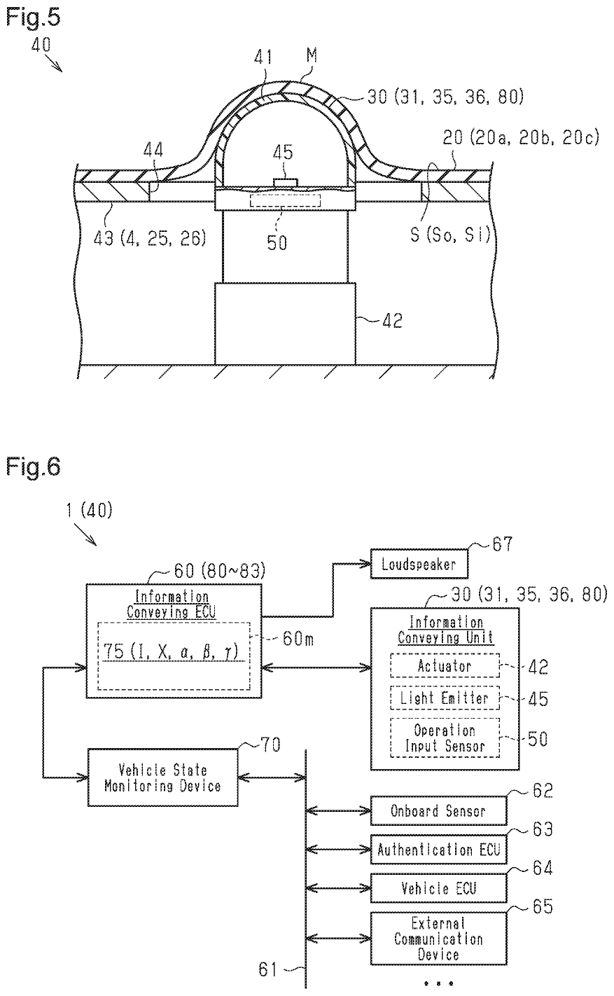

As shown in FIG. 5, the information conveying unit 30 of the vehicle 1 according to the present embodiment pushes the corresponding ornamental surface member 20 from the inner side when information that is to be conveyed to the user is present. The information conveying device 40 conveys information to the user by deforming the ornamental surface S of the ornamental surface member 20.

Specifically, as shown in FIGS. 4 and 5, the information conveying unit 30 of the present embodiment includes a push member 41 that is substantially semispherical and an actuator 42 configured to apply driving force to the push member 41. The actuator 42 of the present embodiment is configured to be extended and retracted by a motor (not shown) used as a drive source. The push member 41 of the present embodiment is fixed to one end of the actuator 42. In the vehicle 1 of the present embodiment, a base 43 covered by the ornamental surface member 20 includes a through-hole 44. The push member 41 of the information conveying unit 30, which is driven by the actuator 42, projects out of the through-hole 44 to push the ornamental surface member 20.

Specifically, as shown in FIG. 5, the information conveying unit 30 of the present embodiment extends the actuator 42 to move the push member 41, which is fixed to the end of the actuator 42, through the through-hole 44, from the inner side to the outer side of the base 43 (lower side to upper side as viewed in FIG. 5). This pushes the semispherical push member 41 against the ornamental surface member 20. The information conveying unit 30 raises the ornamental surface S of the ornamental surface member 20.

As shown in FIG. 4, the information conveying unit 30 retracts the actuator 42 to return the push member 41, which was projecting out of the base 43 through the through-hole 44. The information conveying device 40 of the present embodiment is configured to restore a flat state of the ornamental surface S.

The push member 41 of the present embodiment is made of a transparent material. The information conveying unit 30 of the present embodiment further includes a light emitter 45 arranged inside the semispherical push member 41. The ornamental surface member 20 is translucent in the vehicle 1 of the present embodiment.

The information conveying unit 30 of the present embodiment functions to output light by illuminating the light emitter 45, which is arranged in the push member 41, at the position where the push member 41 deforms the ornamental surface S. The information conveying device 40 of the present embodiment allows various types of information to be conveyed by combining the light output by the light emitter 45 with the deformation of the ornamental surface S.

The information conveying unit 30 of the present embodiment includes a proximity-type operation input sensor 50. The proximity-type operation input sensor 50 may be a capacitance sensor. Thus, the information conveying device 40 of the present embodiment can detect an operation input, such as when the user touches or brings his or her hand close to the deformed form of the ornamental surface S, which has been raised by the actuation of the information conveying unit 30.

More specifically, as shown in FIG. 6, the vehicle 1 of the present embodiment includes multiple information conveying units 30 that are separately controlled and actuated by an information conveying ECU 60. The vehicle 1 of the present embodiment also includes a vehicle state monitoring device 70. The vehicle state monitoring device 70 is configured to monitor a vehicle state, such as the traveling state of the vehicle 1, a surrounding environment, or the situation of an occupant, by communicating with various types of onboard sensors 62, an authentication ECU 63, a vehicle ECU 64, an external communication device 65, or the like over a vehicle network 61. The information conveying ECU 60 of the present embodiment is configured to communicate with the vehicle state monitoring device 70 to select information that is to be conveyed to the user of the vehicle 1. In the information conveying device 40 of the present embodiment, the information conveying ECU 60 is configured to deform the ornamental surface S by actuating the information conveying unit 30 to drive the ornamental surface member 20 and output light from the light emitter 45 at a predetermined position and in a control mode that correspond to the content of the selected information.

The information conveying ECU 60, the authentication ECU 63, and the vehicle ECU 64 may each be circuitry including: 1) one or more processors that operate in accordance with a computer program (software); 2) one or more dedicated hardware circuits (application specific integrated circuits: ASIC) that execute at least part of various processes, or 3) a combination thereof. The processor includes a CPU and memories such as a RAM and a ROM. The memories store program codes or commands configured to cause the CPU to execute processes. The memories, or computer readable media, include any type of media that are accessible by general-purpose computers and dedicated computers.

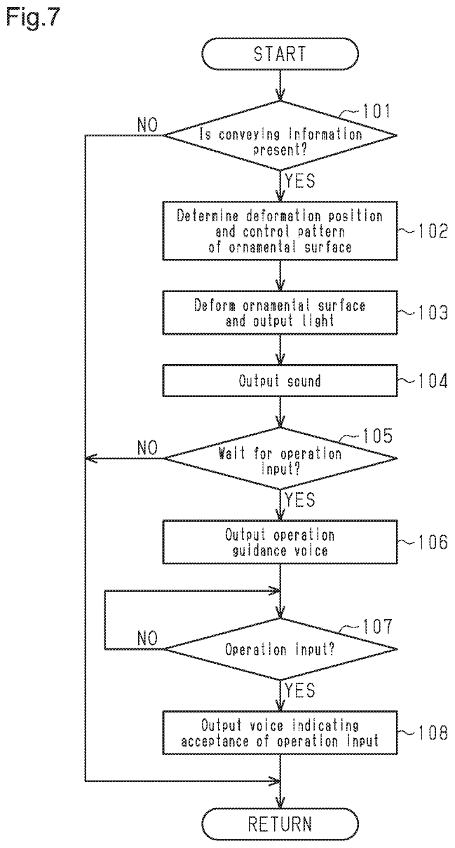

As shown by the flowchart in FIG. 7, the information conveying ECU 60 of the present embodiment communicates with the vehicle state monitoring device 70. If the information conveying ECU 60 selects information that is to be conveyed to the user of the vehicle 1, that is, if information that needs to be conveyed to the user is present (step 101: YES), the information conveying ECU 60 determines a deformation position and a control pattern of the ornamental surface S that correspond to the content of the information (step 102). Based on the determination in step 102, the information conveying ECU 60 controls and actuates the corresponding information conveying unit 30 to deform the ornamental surface S and output light in accordance with the information that needs to be conveyed to the user (step 103).

The information conveying ECU 60 of the present embodiment functions to output sound using an onboard loudspeaker 67 (refer to FIG. 6). In addition to deforming the ornamental surface S and outputting light in step 103, the information conveying ECU 60 is configured to output sound that corresponds to the content of the information (step 104).

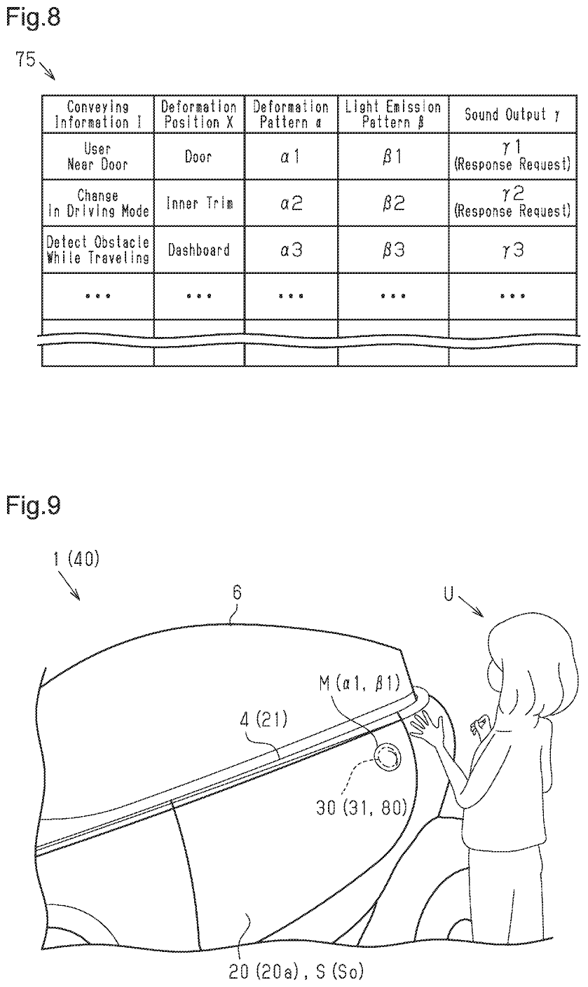

More specifically, as shown in FIGS. 6 and 8, the information conveying ECU 60 of the present embodiment includes a storage region 60m that stores a control table 75. The control table 75 specifies the content of information I that is to be conveyed to the user of the vehicle 1 and the contents of a deformation position X, a deformation pattern α, a light emission pattern β, and a sound output γ of the ornamental surface S that correspond to the content of the information I. The information conveying ECU 60 communicates with the vehicle state monitoring device 70 to determine whether the state of the vehicle corresponds to any one of the contents specified in advance in the control table 75 as the information I that is to be conveyed to the user. That is, the information conveying ECU 60 selects the information I that is to be conveyed to the user of the vehicle 1 by referring to the control table 75. If such information I that needs to be conveyed to the user is present, the information conveying ECU 60 reads the contents of the deformation position X, the deformation pattern α, the light emission pattern β, and the sound output γ of the ornamental surface S that correspond to the content of the information I from the control table 75.

As shown in FIG. 7, the information conveying ECU 60 determines whether the content of the information, which has been conveyed to the user by deforming the ornamental surface S and outputting light in step 103 and outputting sound in step 104, requires a user response, that is, whether to wait for an operation input (step 105). If determined to wait for an operation input (step 105: YES), the information conveying ECU 60 subsequently outputs an operation guidance voice that prompts the user to perform an input operation (step 106). Specifically, the information conveying ECU 60 outputs the operation guidance voice to prompt the user to hold his or her hand near the position where the ornamental surface S is deformed by the actuation of the information conveying unit 30 or touch a deformed form M. If the information conveying ECU 60 subsequently detects an operation input, which is performed by the user, with the operation input sensor 50 of the information conveying unit 30, which was actuated to deform the ornamental surface S (step 107: YES), the information conveying ECU 60 outputs voice indicating that the operation input has been accepted (step 108).

More specifically, as shown in FIGS. 8 and 9, if the information conveying ECU 60 communicates with, for example, the vehicle state monitoring device 70 and detects a user U near the door 4 of the vehicle 1, the information conveying ECU 60 controls and actuates the first information conveying unit 31 arranged in the door 4. This raises and deforms the ornamental surface S formed by the first ornamental surface member 20a arranged on the door 4, that is, the ornamental surface So designed to be viewed by the user U outside the vehicle, and illuminates the light emitter 45 arranged in the first information conveying unit 31.

The information conveying ECU 60 outputs a voice guidance that prompts the user U to touch the deformed form M of the raised ornamental surface So while deforming the ornamental surface So and outputting light. If the information conveying ECU 60 detects an operation input performed by the user U, the information conveying ECU 60 ends the deformation of the ornamental surface So and the light output.

With the information conveying device 40 of the present embodiment, the light output stops after the information conveying unit 30 stops driving the ornamental surface member 20 and the ornamental surface S returns to a substantially flat state. When detecting an operation input of the user U for the deformed form M of the ornamental surface So arranged at the outer side of the vehicle as described above, the vehicle 1 of the present embodiment is configured to unlock the door lock on condition that predetermined security conditions are met.

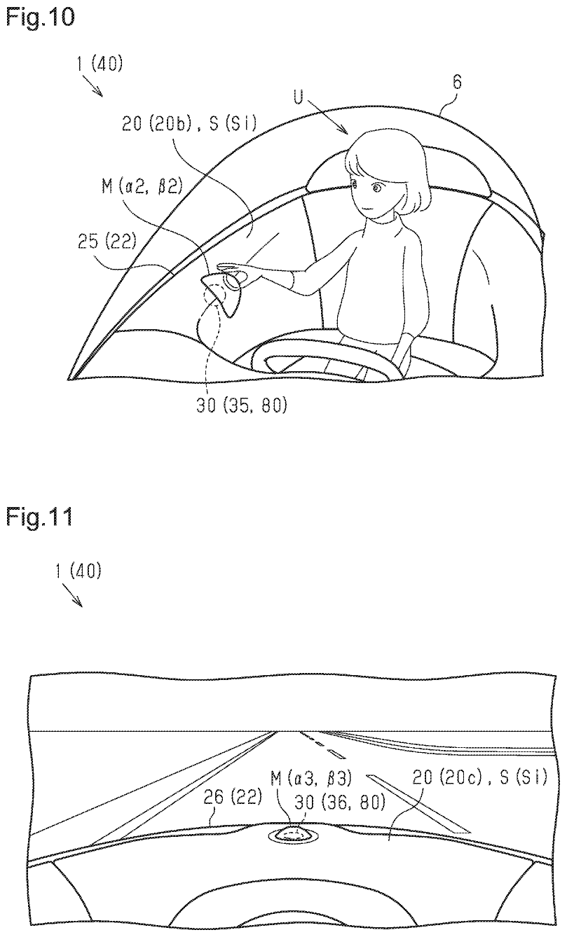

Further, as shown in FIGS. 8 and 10, if the information conveying ECU 60 communicates with the vehicle state monitoring device 70 and detects a change in a driving mode, for example, when approaching an area where an autonomous driving mode is cancelled, the information conveying ECU 60 controls and actuates the second information conveying units 35 arranged in the inner trims 25. This raises and deforms the ornamental surface S formed by the second ornamental surface member 20b arranged on the inner trim 25, more specifically, the ornamental surface Si designed to be viewed by the user U inside the vehicle, and illuminates the light emitter 45 arranged in the second information conveying unit 35.

The information conveying ECU 60 in this case outputs voice to describe the content of the change in the driving mode and a voice guidance that prompts the user U to touch the deformed form M of the raised ornamental surface Si while deforming the ornamental surface Si and outputting light. In this case, if the information conveying ECU 60 detects an operation input performed by the user U for the deformed form M of the ornamental surface Si, the information conveying ECU 60 ends the deformation of the ornamental surface Si and the light output. The vehicle 1 of the present embodiment is configured to shift the driving mode from the autonomous driving mode to a manual driving mode on condition that an operation input performed by the user U has been detected.

Further, as shown in FIGS. 8 and 11, if the information conveying ECU 60 communicates with the vehicle state monitoring device 70 and detects an event that would be an obstacle hindering smooth traveling of the vehicle 1, the information conveying ECU 60 controls and actuates the third information conveying unit 36 arranged in the dashboard 26. This raises and deforms the ornamental surface S formed by the third ornamental surface member 20c arranged on the dashboard 26, more specifically, the ornamental surface Si designed to be viewed by the user U inside the vehicle, and illuminates the light emitter 45 arranged in the third information conveying unit 36.

Specifically, if an obstacle is detected when traveling such as when a vehicle (not shown) in front of the vehicle 1 suddenly slows down, the information conveying ECU 60 actuates the middle one of the three third information conveying units 36 arranged on the dashboard 26. Further, for example, if an obstacle is detected when traveling such as when a front vehicle suddenly changes traffic lanes and approaches from the left or right, the information conveying ECU 60 actuates the right or left third information conveying unit 36 that corresponds to the direction of the obstacle.

In the information conveying device 40 of the present embodiment, the deformation pattern α and the light emission pattern β of the ornamental surface S are set based on urgency of the information I that needs to be conveyed to the user U. Specifically, the information conveying ECU 60 makes changes to the ornamental surface S at a higher speed as the degree of urgency increases. The information conveying ECU 60 flashes the light emitter 45 at a higher speed as the degree of urgency increases. The information conveying ECU 60 is configured to output a warning sound while deforming the ornamental surface S and outputting light when the degree of urgency is high.

As shown in FIGS. 8 to 11, the information conveying device 40 of the present embodiment deforms the ornamental surface S at a higher speed in a deformation pattern α2 indicating a change in the driving mode than a deformation pattern α1 indicating detection of the user U near the door 4. Further, the information conveying device 40 deforms the ornamental surface S at a higher speed in a deformation pattern α3 indicating detection of an obstacle while traveling than the deformation pattern α2 indicating a change in the driving mode. The deformation pattern α3 indicating an obstacle while traveling includes vibration of the deformed form M. This allows the information conveying device 40 of the present embodiment to effectively convey the information I to the user U of the vehicle 1.

In the same manner, with respect to the light emission pattern β, the light emitter 45 flashes at a higher speed in a light emission pattern β2 indicating a change in the driving mode than a light emission pattern β1 indicating detection of the user U near the door 4. Further, the light emitter 45 flashes at a higher speed in a light emission pattern β3 indicating detection of an obstacle while traveling than the light emission pattern β2 indicating a change in the driving mode. Voice outputs γ1, γ2 respectively corresponding to the detection of the user U and a change in the driving mode include a voice guidance that prompts the user U to perform an operation input, that is, requests the user U for a response. However, a voice output γ3 indicating detection of an obstacle while traveling does not include a response request to the user U. The information conveying device 40 of the present embodiment is configured to continue outputting a warning to the user U as long as an obstacle is detected.

The advantages of the present embodiment will now be described.

(1) The information conveying device 40 includes the ornamental surface member 20 that is elastic and deformable. The ornamental surface member 20 forms the ornamental surface S designed to be viewed by the user U of the vehicle 1. The information conveying device 40 also includes the information conveying unit 30 arranged at the inner side of the ornamental surface member 20 and the information conveying ECU 60 that controls and actuates the information conveying unit 30. The information conveying unit 30 and the information conveying ECU 60 form an ornamental surface deformation unit 80 that drives the ornamental surface member 20 to deform the ornamental surface S when information I that needs to be conveyed to the user U is present.

With this configuration, the three-dimensional deformed form M of the ornamental surface S visually indicates the information I that needs to be conveyed to the user U. This attracts the attention of the user U and effectively conveys the information I.

(2) The information conveying device 40 includes multiple information conveying units 30 arranged at different positions on the vehicle 1. The information conveying ECU 60 is configured to deform the ornamental surface S by using one of the information conveying units 30 arranged at the position that corresponds to the content of the information I that needs to be conveyed to the user U.

This configuration allows for indication of the content of the information I that needs to be conveyed to the user U in association with the deformation position X of the ornamental surface S. For example, the subject and direction of the information I can be indicated. This effectively conveys the information I to the user U of the vehicle 1.

(3) The information conveying ECU 60 is configured to control and actuate the information conveying unit 30 to deform the ornamental surface S in a deformation pattern α that corresponds to the content of the information I that needs to be conveyed to the user U.

This configuration allows for indication of the content of the information I that needs to be conveyed to the user U in association with the deformation pattern α of the ornamental surface S. For example, the degree of urgency can be indicated by the deformation speed and the size of a deformed portion. This effectively conveys the information I to the user U of the vehicle 1.

(4) The information conveying unit 30 is configured to push the ornamental surface member 20 from the inner side to deform the ornamental surface S of the ornamental surface member 20. This obtains the three-dimensional deformed form M in the ornamental surface S with a simple structure.

(5) The ornamental surface member 20 is made of a translucent material. The information conveying unit 30 includes the light emitter 45 arranged at the inner side of the ornamental surface member 20. The information conveying ECU 60 serves as a light emission control unit 81 that illuminates the light emitter 45 at the position of the ornamental surface S deformed by the actuation of the information conveying unit 30.

With this configuration, light output by the light emitter 45 illuminated inside the three-dimensional deformed form M in the ornamental surface S indicates various types of information. This effectively conveys the information I to the user U of the vehicle 1.

(6) The information conveying ECU 60 is configured to illuminate the light emitter 45 in the light emission pattern β that corresponds to the content of the information I that needs to be conveyed to the user U.

This configuration allows for indication of the content of the information I that needs to be conveyed to the user U in association with the light emission pattern β of light output using the light emitter 45. For example, the degree of urgency can be indicated by the speed at which the light emitter 45 is switched on and off and the color tone of the light emitter 45. This effectively conveys the information I to the user U of the vehicle 1.

(7) The information conveying unit 30 includes the operation input sensor 50 that detects an operation input performed by the user U at the position of the ornamental surface S deformed by the actuation of the information conveying unit 30. This allows for bidirectional conveyance of information in which the user U responds to the deformation of the ornamental surface S.

(8) The information conveying ECU 60 serves as an operation guidance control unit 82 that outputs voice prompting the user U to perform an operation input at the position of the deformed ornamental surface S while deforming the ornamental surface S. This allows for bidirectional conveyance of information in which the user U responds to the deformation of the ornamental surface S.

(9) The information conveying ECU 60 is configured to deform the ornamental surface So, which is designed to be viewed by the user U outside the vehicle, by controlling and actuating the information conveying unit 30 arranged in the door 4 of the exterior member 21 of the vehicle 1 and driving the first ornamental surface member 20a. This effectively conveys information I to the user U outside the vehicle.

(10) The information conveying ECU 60 is configured to deform the ornamental surface Si, which is designed to be viewed by the user U inside the vehicle, by controlling and actuating the second and third information conveying units 35, 36 arranged in the inner trims 25 and the dashboard 26 of the interior member 22 of the vehicle 1 and driving the second and third ornamental surface members 20b, 20c. This effectively conveys information I to the user U inside the vehicle.

(11) The information conveying ECU 60 includes the control table 75 that stores the content of information I to be conveyed to the user U of the vehicle 1. The information conveying ECU 60 serves as an information selection unit 83 configured to select the information I that needs to be conveyed to the user U by referring to the control table 75. This conveys appropriate information I to an occupant of the vehicle 1.

The above-described embodiment may be modified as follows. The above-described embodiment and the following modifications can be combined as long as the combined modifications remain technically consistent with each other.

In the above embodiment, the door 4 of the exterior member 21 of the vehicle 1, the inner trims 25 of the interior member 22 of the vehicle 1, and the dashboard 26 of the interior member 22 of the vehicle 1 each include a separate information conveying unit 30. The ornamental surface S is deformed by controlling and actuating the information conveying unit 30 to drive the corresponding ornamental surface member 20. Instead, the deformation positions X of the ornamental surface S and the number of the deformation positions X may be changed in any manner. A single information conveying unit 30 may deform the ornamental surface S at multiple deformation positions X.

The ornamental surface So designed to be viewed by the user U outside the vehicle may be deformed by driving the ornamental surface member 20 arranged in another exterior member 21 such as a bumper, a front grille, or a hood. The ornamental surface Si designed to be viewed by the user U inside the vehicle may be deformed by driving the ornamental surface member 20 arranged in another interior member 22 such as a dashboard, a center console, or a ceiling panel.

In the above embodiment, the information conveying ECU 60 controls the actuation of the information conveying unit 30. Instead, the information conveying unit 30 and the information conveying ECU 60 may be integrated. The information conveying ECU 60 communicates with the vehicle state monitoring device 70 to select information I that is to be conveyed to the user U of the vehicle 1. Alternatively, the information conveying ECU 60 may also serve as the vehicle state monitoring device 70. The information conveying ECU 60 or the vehicle state monitoring device 70 may be implemented outside the vehicle using an external communication device.

In the above embodiment, the information conveying unit 30 pushes the ornamental surface member 20 from the inner side to raise and deform the ornamental surface S. However, the driving of the ornamental surface member 20 to deform the ornamental surface S may be changed in any manner That is, the configuration of the ornamental surface deformation unit 80 may be changed in any manner. For example, the ornamental surface member 20 may be pulled from the inner side to depress and deform the ornamental surface S. Further, the ornamental surface S may be deformed using, for example, an actuator embedded in the ornamental surface member 20. The ornamental surface member 20 may be made of a material that deforms when energized to directly drive the ornamental surface member 20.

In the above embodiment, the information conveying device 40 deforms the ornamental surface S when detecting the user U near the door, a change in the driving mode, an obstacle while the vehicle 1 is traveling. However, the content of information I that is to be conveyed to the user U of the vehicle 1 may be set in any manner

The deformation pattern α of the ornamental surface S may be changed in any manner In addition to the vertical movement, a lateral movement, a rotational movement, and the like of the deformed form M may be combined. The deformation speed and the size of the deformed form M may be changed. The light emission pattern β of light output using the light emitter 45 may be changed in any manner. The light emitter 45 may be flashed at a higher speed or illuminated in color tones that would be more alarming as the degree of urgency increases. Sound output may be changed in any manner when deforming the ornamental surface S and outputting light.

In the above embodiment, the information conveying unit 30 includes the proximity-type operation input sensor 50. However, the operation input sensor 50 is not limited to a proximity-type sensor. Instead, a touch sensor, a camera, or the like may be used to detect the user U touching the three-dimensional deformed form M in the ornamental surface S.

In the above embodiment, the deformation of the ornamental surface S is accompanied with light output and sound output. Alternatively, at least one of light output and sound output may be omitted when the ornamental surface S is deformed.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle information conveying device comprising:
at least one ornamental surface member that is elastic and deformable, wherein the at least one ornamental surface member includes an ornamental surface designed to be viewed by a user of a vehicle; and
at least one ornamental surface deformation unit configured to drive the ornamental surface member and deform the ornamental surface when information that is to be conveyed to the user is present.

2. The vehicle information conveying device according to claim 1, wherein the ornamental surface deformation unit is configured to deform the ornamental surface at a position that corresponds to content of the information.

3. The vehicle information conveying device according to claim 1, wherein the ornamental surface deformation unit is configured to deform the ornamental surface in a deformation pattern that corresponds to content of the information.

4. The vehicle information conveying device according to claim 1, wherein the ornamental surface deformation unit is configured to deform the ornamental surface by pushing the ornamental surface member from an inner side.

5. The vehicle information conveying device according to claim 1, further comprising:
a light emitter arranged at an inner side of the ornamental surface member, wherein the ornamental surface member is translucent; and
a light emission control unit configured to illuminate the light emitter at a position where the ornamental surface is deformed.

6. The vehicle information conveying device according to claim 5, wherein the light emission control unit is configured to illuminate the light emitter in a light emission pattern that corresponds to content of the information.

7. The vehicle information conveying device according to claim 1, further comprising an operation input sensor that detects an operation input performed by the user at a position where the ornamental surface is deformed.

8. The vehicle information conveying device according to claim 7, further comprising an operation guidance control unit configured to output voice prompting the user to perform the operation input while deforming the ornamental surface.

9. The vehicle information conveying device according to claim 1, wherein
the at least one ornamental surface member includes an ornamental surface member arranged on an exterior member of the vehicle, and
the at least one ornamental surface deformation unit includes an ornamental surface deformation unit configured to drive the ornamental surface member that is arranged on the exterior member to deform an ornamental surface designed to be viewed by the user outside the vehicle.

10. The vehicle information conveying device according to claim 1, wherein
the at least one ornamental surface member includes an ornamental surface member arranged on an interior member of the vehicle, and
the at least one ornamental surface deformation unit includes an ornamental surface deformation unit configured to drive the ornamental surface member that is arranged on the interior member to deform an ornamental surface designed to be viewed by the user inside the vehicle.

11. The vehicle information conveying device according to claim 1, further comprising an information selection unit configured to select information that is to be conveyed to the user.
